(19) United States
(12) Patent Application Publication
(10) Pub. No.: US 2019/0077289 A1
(43) Pub. Date: Mar. 14, 2019

(54) MASSAGE DEVICE FOR A VEHICLE SEAT, VEHICLE SEAT, AND METHOD FOR PRODUCING A VEHICLE SEAT

(71) Applicant: Brose Fahrzeugteile GmbH & Co., Coburg (DE)

(72) Inventors: Christian Mergl, Zeil/Main (DE); Wojciech Falinski, Coburg (DE); Gregor Kröner, Bischberg (DE)

(21) Appl. No.: 15/749,092

(22) PCT Filed: Aug. 3, 2016
(86) PCT No.: PCT/EP2016/068520

§ 371 Date: May 8, 2018

(30) Foreign Application Priority Data
Aug. 7, 2015 (DE) 10 2015 215 170.0

(51) Int. Cl. B60N 2/90

(52) U.S. Cl. CPC B60N 2/976; A61H 23/0263

(57) ABSTRACT

The present invention relates to a massage device for a vehicle seat, comprising: a number of massage units which can be integrated in upholstery of a vehicle seat; a control device which is designed to activate the massage units, or a central connector which provides a connection for controlling the massage units; at least one connection apparatus which couples the massage units to the control device; wherein the control device or the central connector and/or the massage units and/or the connection apparatus comprise(s) means for ensuring that at least the massage units are installed in a manner that is unique in terms of position and/or orientation. The present invention also relates to a vehicle seat comprising a massage device of this kind, and to a method for producing a vehicle seat of this kind.

### FIELD OF THE INVENTION

The present invention relates to a massage device for a vehicle seat, to a vehicle seat comprising a massage device of this kind, and to a method for producing a vehicle seat of this kind.

### TECHNICAL BACKGROUND

Massage devices for vehicle seats are available in various designs.

DE 10 2009 033 041 A1 describes a vehicle seat comprising a massage apparatus which has a plurality of unbalance motors which can be activated by a control device and are together fixed to a flexible support.

A support of this kind has to be individually designed and made for each type of vehicle seat.

### SUMMARY OF THE INVENTION

Against this background, the object of the present invention is to provide an improved massage device for a vehicle seat.

This object is achieved according to the invention by a massage device having the features of claim 1 and/or by a vehicle seat having the features of claim 12 and/or by a method having the features of claim 14.

Accordingly, there is provided:
a massage device for a vehicle seat, comprising: a number of massage units which can be integrated in upholstery of a vehicle seat; a control device which is designed to activate the massage units, or a central connector which provides a connection for controlling the massage units; at least one connection apparatus which couples the massage units to the control device; wherein the control device or the central connector and/or the massage units and/or the connection apparatus comprise(s) means for ensuring that at least the massage units are installed in a manner that is unique in terms of position and/or orientation;
a vehicle seat, in particular for motor vehicles, comprising at least one piece of upholstery, a cover which is stretched over the upholstery, and a massage device according to the invention, wherein at least the massage units are provided so as to be integrated in the upholstery;
a method for producing a vehicle seat, in particular a vehicle seat according to the invention, comprising the steps of: providing a massage device according to the invention; providing upholstery which has recesses for inserting the massage units; and inserting the massage units into the recesses provided therefor.

The concept forming the basis of the present invention consists in providing a massage device so as to be usable in different types of vehicle seat, and thereby designing said device such that incorrect installation is prevented, said device comprising means for ensuring that at least the massage units are installed in a manner that is unique in terms of position and/or orientation. According to the invention, a certain degree of flexibility is therefore achieved with regard to the possibility of using the massage device in different vehicle seats, without this posing the risk of incorrect installation. Furthermore, according to the invention, despite this flexibility, a high degree of process reliability and a short cycle time are advantageously made possible during mounting of a vehicle seat.

A number of massage units can indicate a singular massage unit or a plurality of massage units.

The massage units are individual massage units or massage units that are preassembled in groups. Accordingly, so as to be mounted in a vehicle seat, the massage units can be provided individually or some of the massage units and/or some parts of the connection apparatus can be preassembled in groups and/or pre-cabled.

The massage units can preferably be integrated directly in the upholstery of the vehicle seat, in particular the seat upholstery and the backrest upholstery. In addition, the massage units can similarly also be integrated in the upholstery of further back supports and/or the headrest for neck or head massages and/or in a foot well or in a footrest for foot massages and/or in a calf rest for calf massages.

For example, the massage units can be in the form of unbalance motors. A weight that is arranged on the armature shaft of the motor and is eccentric with respect to the axis of rotation of the motor is used in the case of an unbalance motor. Rotation of the motor results in a vibration, which is transmitted to an occupant for example through a cover of the vehicle seat in the form of a massage.

A control device controls the massage units, in particular the rotational speed of the unbalance motors and thus the vibration frequency thereof. The control device may be part of the massage device. Alternatively, control can also be carried out by an external control device. In this case, a central connector is provided on the massage device, in particular in place of a control device, which connector provides a connection for controlling the massage units. For this purpose, a central connector of this kind can be designed such that it can be directly coupled to an external controller, a cable assembly of a vehicle or a bus of a vehicle, in particular a central bus.

Advantageous embodiments and developments will become apparent from the additional dependent claims and from the description with reference to the figures of the drawings.

According to one embodiment, the connection apparatus is asymmetrical. In particular, said connection apparatus is a cable harness, cables that leave said harness at the same level and that are in particular intended to branch off in different directions being of different lengths. The different lengths preferably correspond to the spacing between recesses provided in the upholstery of a vehicle seat at the relevant level in order to receive the massage units and the cable harness at the position assigned thereto when installed. Therefore, it is advantageously ensured that, during mounting, cables branching off at the same level of the cable harness are each placed on the recess provided therefor, since each cable has a length which is only suitable for one of the recesses arranged at the corresponding level.

According to a further embodiment, the connection apparatus is designed such that the control device or the central connector is arranged asymmetrically. In particular, a controller or a central connector is provided for being positioned at the bottom of a corresponding cable harness. Advantageously, the position of the control device or the central connector is thus also uniquely fixed.

According to an advantageous embodiment, the massage units are provided so as to be arranged symmetrically in the vehicle seat. Accordingly, the connection apparatus connects each of the massage units to the control device or the central connector by means of a cable. For this purpose, the cables have an asymmetrical structure. The asymmetrical structure is preferably achieved by the cables leaving a cable harness at different lengths. It being possible for the massage units to be arranged symmetrically in this way results in an occupant of a vehicle seat advantageously being massaged evenly on both sides of the body, and this is considered to be particularly comfortable.

According to one embodiment, an individual cable length is assigned to each massage unit. The particular cable length is preferably specified by the arrangement of associated recesses provided in upholstery of the vehicle seat in order to receive the massage units. In particular, when the connection apparatus is asymmetrical, each massage unit has a different spacing or cable course having a different length, even when the massage units are intended to be arranged symmetrically on the vehicle seat. Therefore, each cable is advantageously only suitable for one recess in the upholstery of the vehicle seat, owing to the individual length thereof. This reliably prevents incorrect installation.

According to a further embodiment, at least the connection apparatus is provided so as to be foamed into the upholstery. Therefore, the progression of the connection apparatus in the upholstery is already fixed before the massage units are mounted. It is therefore advantageously ruled out that the connection apparatus be incorrectly installed or incorrectly connected.

According to one embodiment, the control device or the central connector is provided so as to be foamed into the upholstery.

Therefore, the position of the control device or the central connector is advantageously already fixed before at least the massage units are mounted. Therefore, a constraint is imposed on the installation of the remaining components, in particular including the connection apparatus, which prevents said connection apparatus from being incorrectly installed or incorrectly connected.

According to a further embodiment, the massage units provided for being integrated at different points in the upholstery are shape-coded on the outside thereof. The purpose of this is to allow shape-coded massage units to only be inserted into shape-coded recesses accordingly provided in the upholstery. In particular, the massage units have for this purpose a housing shaped according to the shape coding. It is therefore advantageously ruled out that a massage unit be inserted into a recess in the upholstery that is not the one provided therefor. This is advantageous in particular when the massage units are pre-cabled, since the individual massage units are arranged correctly as a result of the predetermined cabling.

According to one embodiment, the massage units provided for being integrated at different points in the upholstery and/or cables of the connection apparatus that are provided for being integrated at different points in the upholstery are colour-coded so as to be inserted at colour-coded points and/or in colour-coded recesses that are accordingly provided in the upholstery. The purpose of this is to ensure that, during mounting, the relevant colour-coded component is inserted into colour-coded recesses accordingly provided in the upholstery. During mounting, a worker is therefore advantageously aided by the fact that he can visually assign the individual components to associated recesses in the upholstery, and this prevents incorrect installation.

According to one embodiment, when there is a preassembled group of massage units, the connections thereof are combined in a common connection cable. For example, a common connection cable of this kind is designed to be arranged on the edge or in the centre of a vehicle seat. Advantageously, during mounting, contact can therefore be made quickly and easily.

According to one embodiment of a vehicle seat, the massage units and at least part of the connection apparatus are arranged so as to be covered by the cover, in particular so as not to be visible from the outside. In this case, an additional foam layer is preferably arranged between the massage devices and the cover. The additional foam layer is designed as a thin foam layer and prevents the hard housing of the massage units from being directly visible through the cover.

Therefore, the external appearance of the vehicle seat is advantageously not influenced by the massage device and sitting comfort is not adversely affected. In particular, advantageously, the intended seat height is maintained, intended lateral support is provided, and it is possible to combine the provision of massages with seat heating.

According to one embodiment of a method for producing a vehicle seat, the individual massage units are inserted according to colour and/or shape coding provided on the massage units and on the recesses. As a result of shape coding, it is advantageously ruled out that a massage unit be inserted into a recess in the upholstery of the vehicle seat that is not the one provided therefor. This is advantageous in particular when the massage units are pre-cabled, since the massage units are in particular arranged correctly as a result of the predetermined cabling. As a result of colour coding, during mounting, a worker is advantageously aided by the fact that he can visually assign the individual components to associated recesses in the upholstery, and this likewise prevents incorrect installation.

According to one embodiment of a method for producing a vehicle seat, a step of contacting the connection apparatus is provided.

In particular, the step of contacting the connection apparatus comprises connecting the massage units to asymmetrically arranged cables of different lengths, a cable length specified by the arrangement of the associated recesses being assigned to each massage unit. Advantageously, a massage unit brought into contact with the relevant cable can only be positioned in the associated recess, without the cable length having to be adapted, and this prevents incorrect installation.

Furthermore, the step of contacting the connection apparatus can alternatively or additionally comprise in particular connecting cables integrated in the massage units to the controller or the central connector.

Moreover, the step of contacting the connection apparatus can alternatively or additionally comprise in particular connecting a common connection cable of a group of massage units to the controller or the central connector or a cable harness connected to the controller or the central connector.

According to one embodiment of a method for producing a vehicle seat, a step of connecting a cable harness of the massage device to a control device of the massage device is provided.

Alternatively or additionally, a step of connecting a central connector of the massage device to an external controller, a cable assembly of a vehicle or a bus of a vehicle, in particular a central bus, is provided.

The above embodiments and developments can be combined with one another as desired, where appropriate. In particular, features of the massage device, features of the vehicle seat and features of the method for producing the vehicle seat can be transferred to one another, where appropriate. Further possible embodiments, developments and implementations of the invention also include combinations of features of the invention that have been previously described or are described in the following with respect to the embodiments, even if not explicitly mentioned. In particular, a person skilled in the art will also add individual aspects as improvements or additions to the relevant basic form of the present invention.

### SUMMARY OF THE DRAWINGS

The present invention is explained below in greater detail with reference to the embodiments specified in the schematic figures of the drawings, in which:

FIG. 1 shows a first embodiment of a vehicle seat and a massage device;

FIG. 2 shows a second embodiment of a vehicle seat and a massage device;

FIG. 3 shows a third embodiment of a vehicle seat and a massage device;

FIG. 4 is a schematic view of recesses provided in the upholstery of a vehicle seat, according to the third embodiment;

FIG. 5 is a schematic view of a connection element that is foamed into upholstery of a vehicle seat.

The accompanying figures of the drawings are intended to provide further understanding of the embodiments of the invention.

They illustrate embodiments and, together with the description, are used to explain principles and concepts of the invention. Other embodiments and many of the mentioned advantages will become apparent from the drawings. The elements of the drawings are not necessarily shown to scale relative to one another.

In the figures of the drawings, identical, functionally equivalent and equivalently operating elements, features and components are provided with the same reference signs in each case, unless stated otherwise.

### DESCRIPTION OF EMBODIMENTS

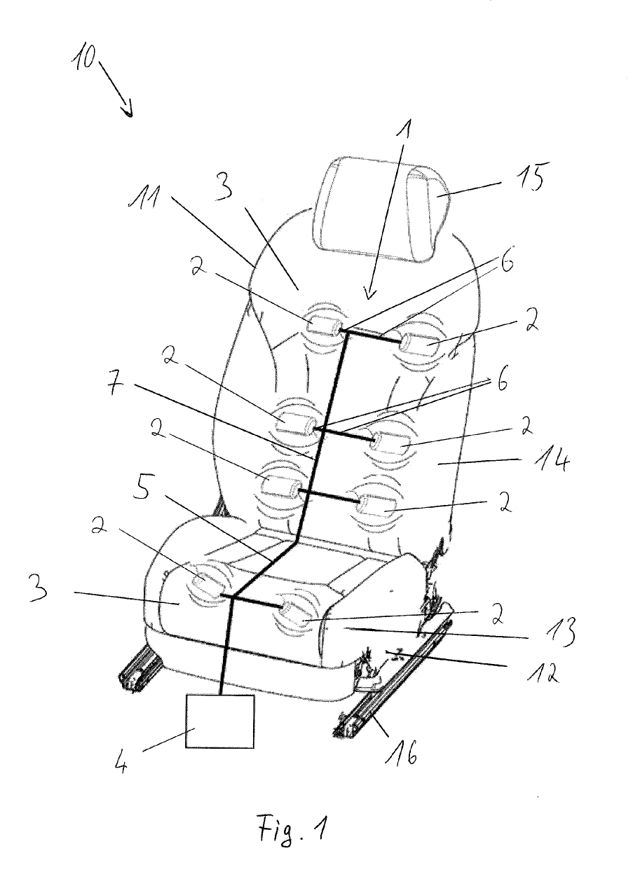

FIG. 1 shows a first embodiment of a vehicle seat 10 and a massage device 1.

The vehicle seat 10 has a base 12 running in guide rails 16, a sitting surface 13, a backrest 14 and a headrest 15. Arm rests (not shown) may also be provided.

The massage device 1 is shown such that it is integrated in the vehicle seat 10. Said device has a plurality of massage units 2 that are integrated in upholstery 3 of the vehicle seat 10. In the present embodiment, both the sitting surface 13 and the backrest 14 have upholstery 3 of this kind. In addition, it would also be conceivable for massage units to be provided in the upholstery of the headrest and/or in upholstery of an armrest and/or in upholstery of a calf support or in a floor mat in the region of a footrest assigned to the vehicle seat 10.

Furthermore, a control device denoted by element 4 can be provided, which is provided for and designed to activate all the massage units 2. This may be for example a computing device comprising a corresponding computer program, or a controller that provides the individual massage units with suitable control signals. The control device 4 can in turn be coupled to a human-machine interface, for example a button panel or a touchscreen operating module, or to the operating unit of an entertainment system of a vehicle, by means of which interface an occupant can operate the massage device 1.

Instead of a control device, a central connector 4, also denoted by element 4 in the present embodiment, can also be provided on the massage device 1, which connector provides a connection for controlling the massage units 2. In this case, the massage units 2 are controlled by means of an external control device which is provided in particular in a vehicle. For example, control can be carried out by means of a body control module of a vehicle which activates the massage units by means of the central connector.

A connection apparatus 5 is also provided, which couples the control device or the central connector 4 to the massage units 2. For this purpose, the connection apparatus 5 has a cable harness 7 in which at least one cable 6 is packaged for each massage unit 2. The cables 6 branch off from the cable harness 7 at the relevant points, in particular at the level of the massage units 2 assigned thereto and, when fitted, come into contact with the relevant massage unit 2.

The cable harness 7 extends laterally or asymmetrically in the upholstery 3 rather than centrally. In addition, the cables 6 branching off at the same level have different lengths. The connection apparatus 5 is thus asymmetrical.

Consequently, a predetermined cable 6 is assigned to the predetermined position of each massage unit 2 and is provided with an individual cable length so that it can be laid only directly in said predetermined position of the relevant massage unit 2, in particular without shortening or lengthening the cable. If a cable 6 were to be laid in a different position of a different massage unit, to which it has not been assigned, it would be too short or too long and thus would not be suitable for this different position. In such a case, the incorrect position would be indicated to a worker laying the cable as a result of the unsuitable cable length.

The cable harness 7 is brought into contact with the control device or the central connector 4 centrally. For this purpose, for example an asymmetrical plug having a predetermined pinout can be provided, which plug lays the cables 6 that are predetermined for the individual massage units 2 on likewise predetermined pins. The asymmetrical arrangement of the cables 6 is thus also reproduced when connecting the control device or the central connector 4, by means of the asymmetrical plug. Accordingly, the control device or the central connector 4 has a corresponding asymmetrical counter plug. It is thus ensured that there is correct contacting/plugging-in between the individual cables 6 of the cable harness 7.

In accordance with the asymmetrical or non-central arrangement of the cable harness 7, the control device or the central connector 4 is also arranged asymmetrically or non-centrally on the vehicle seat 10.

In contrast with the connection apparatus 5, the massage units 2 are integrated so as to be distributed symmetrically on the relevant upholstery 3. An individual cable length is assigned in this case to each massage unit 2. This is specified by the position or arrangement of a recess 8 assigned to the relevant massage unit 2.

The massage units 2 are individual massage units in the embodiment shown. The massage units 2 each comprise an unbalance motor (not shown in detail for the sake of clarity) which generates vibrations that can be used for massages. A weight that is arranged on the armature shaft of the motor and is eccentric with respect to the axis of rotation of the motor is used in the case of an unbalance motor of this kind. Rotation of the motor results in a vibration, which is transmitted to an occupant through a cover 11 of the vehicle seat 10 in the form of a massage.

The control device 4 or an external control device via the central connector 4 controls the rotational speed of the unbalance motors of the massage units 2 and thus the vibration frequency thereof. Accordingly, the control device 4 or an external control device can play back a massage program in which the various massage units 2 are appropriately activated to provide a massage.

In the embodiment shown, the control device or the central connector 4 is arranged outside of the vehicle seat 10. This is purely schematic, however. In other embodiments, the control device or the central connector 4 can also be integrated in the vehicle seat 10, for example in the base 12 thereof or in the upholstery 3.

In order to mount the massage device 1 in the vehicle seat 10, the massage units 2 are brought into contact with the cables 6 of the connection apparatus 5 that are assigned thereto, and are inserted into the recess 8 assigned thereto in each case. In the process, either the contacting can take place first, followed by the insertion, or the insertion can take place first, followed by the contacting. The insertion and contacting of the massage units 2 take place separately in each case.

In a subsequent production step for the upholstery, a thin foam layer is provided between the cover 11 and the massage units 2 and the upholstery 3 is overlaid with the cover 11. When mounted, the massage units 2 are thus completely upholstered.

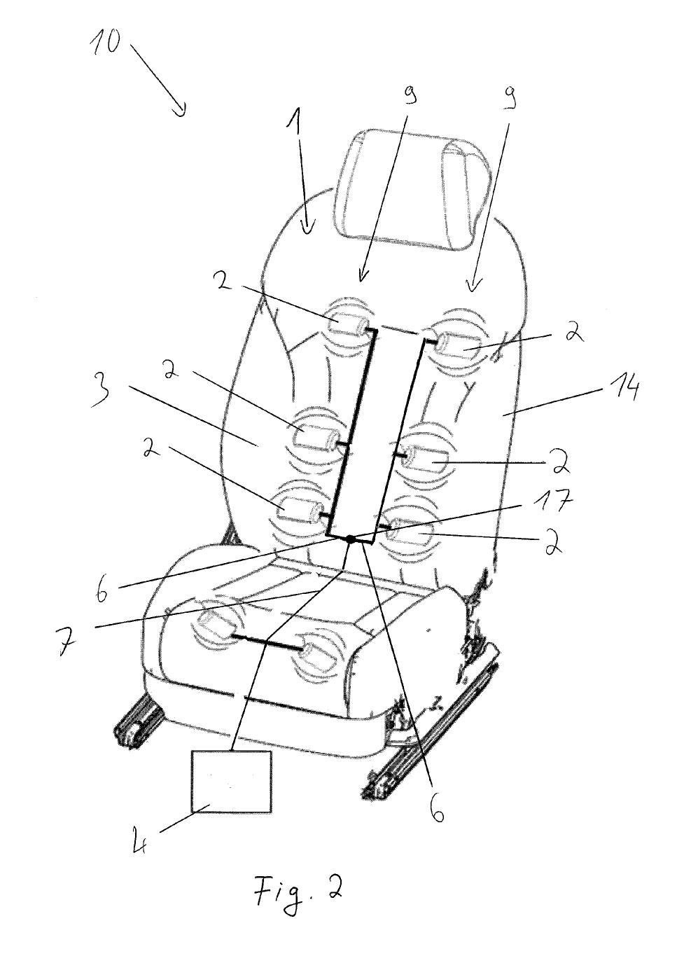

FIG. 2 shows a second embodiment of a vehicle seat 10 and a massage device 1.

In contrast with the first embodiment according to FIG. 1, in this second embodiment, the massage units 2 are arranged and contacted or cabled in groups 9. For this purpose, the groups 9 are preassembled or pre-cabled. In the embodiment shown, this means that, for the purpose of integration in the left-hand side of the upholstery 3 of the backrest 14, a first group 9 of three massage units 2 is already brought into contact with a common connection cable 6 before mounting. Said common connection cable 6 is guided from the left-hand side towards the centre of the vehicle seat 10, during mounting, before or after the massage units 2 have been inserted into the left-hand side of the upholstery 3 and, in this position, said cable is coupled to the cable harness 7 of the connection apparatus 5. Analogously, a second group 9 of three massage units 2, which are provided for integration in the right-hand side of the upholstery 3 of the backrest 14, are inserted into the right-hand side of the upholstery 3 and are coupled to the cable harness 7 of the connection apparatus 5 by means of a common connection cable 6.

The respective three massage units 2 of the left-hand and the right-hand group 9 are in each case predetermined for mounting at a predetermined height of the backrest 14. Said units are provided with a cable length corresponding to said predetermined mounting height, and therefore, proceeding from a connection point 17 of the common connection cable 6 on the relevant side of the upholstery 3, there is only one recess that corresponds to the relevant cable length in the upholstery 3. Incorrect installation is thus effectively prevented.

Asymmetrical plugs are provided at the connection point 17 and at the connection cables 6, which plugs can be interconnected only in the predetermined contacting process. It is thus ensured that the connection cable 6 is brought into contact with the cable harness 7 correctly.

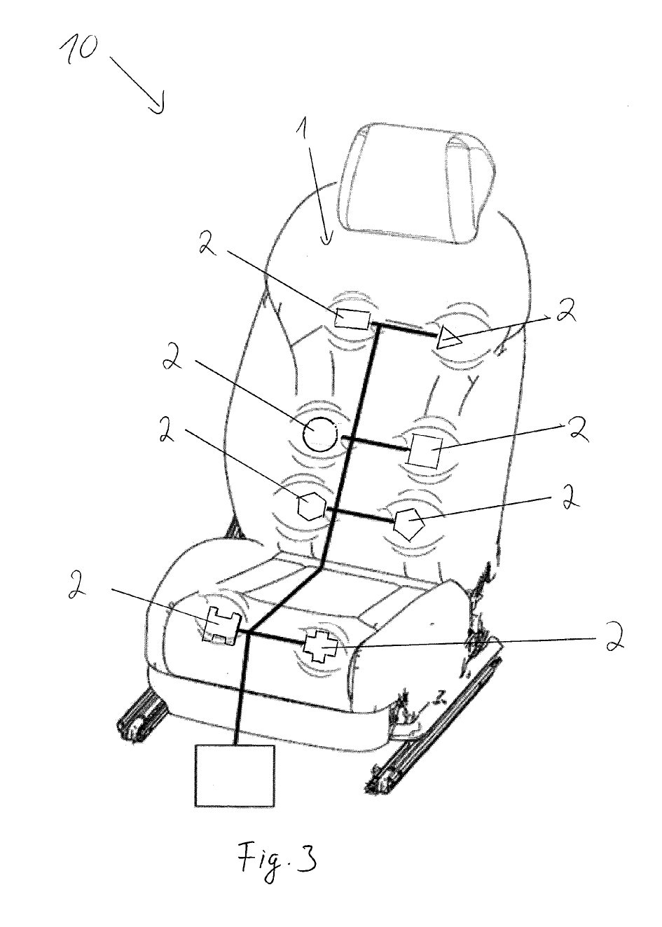

FIG. 3 shows a third embodiment of a vehicle seat 10 and a massage device 1.

In contrast with the first embodiment, in this third embodiment, the massage units 2 are provided so as to be shape-coded. In addition, each massage unit 2 has a housing having an individual shape.

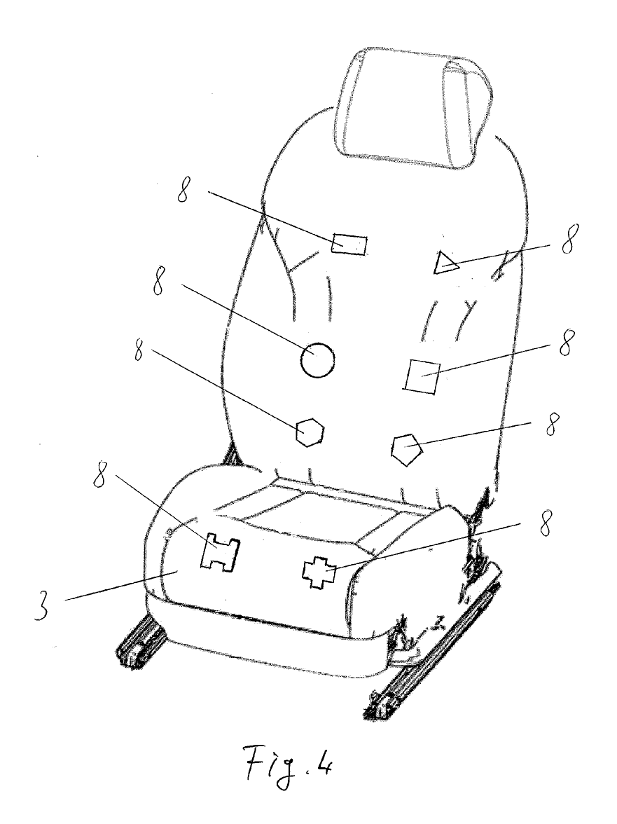

FIG. 4 is a schematic view of recesses 8 provided in the upholstery 3 of the vehicle seat 10, according to the third embodiment.

Here, in each case only one recess 8 within the upholstery 3 has a shape that corresponds to the individual shape of a housing of a shape-coded massage unit 2. It is thus ensured that only mutually corresponding massage units 2 and recesses 8 can be fitted together. Compliance with predetermined positioning of the massage units 2 in the upholstery 3 is thus ensured during mounting.

Similarly, corresponding colour-coding, i.e. colouring housings of the massage units 2 and colouring recesses in the upholstery 3, can also be provided instead of or in addition to corresponding shapes. The colour-coding can also be extended to the cables 6 of the connection apparatus 5, such that for example differently coloured cables and correspondingly coloured slots in the upholstery 3 for laying said cables are provided.

Shape-coding and/or colour-coding of this kind is expedient in particular if different massage units 2 are provided for different positions on the upholstery 3, for example for different heights of the backrest 14 and/or for seat upholstery and the backrest and/or for the left-hand side and the right-hand side.

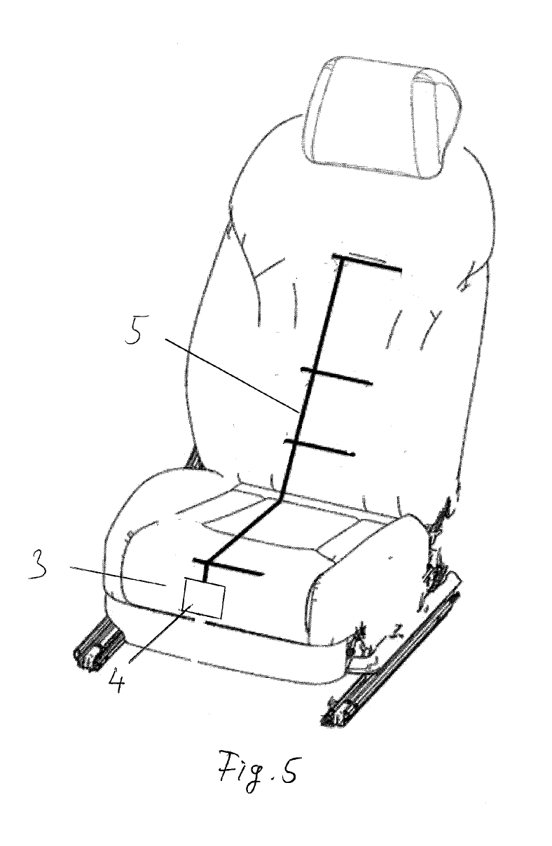

FIG. 5 is a schematic view of a connection apparatus 5 that is foamed into upholstery 3 of a vehicle seat 10.

In the embodiment shown, the control device or the central connector 4 is also foamed into the upholstery 3, in addition to the connection apparatus 5. The upholstery 3, the connection apparatus 5 and the control device or the central connector 4 thus form a prefabricated or preassembled module.

For the final mounting of the massage device 1, the massage units 2 are inserted into the recesses 8 (not shown here) in the upholstery 3 and are brought into contact with the connection apparatus 5. The upholstery 3, together with the massage units 2, the connection apparatus 5 and the control device or the central connector 4, are then covered with the cover 11 or said cover is stretched thereover. Thus, when the massage device 1 is finally mounted, the connection apparatus 5, the massage units 2 and the controller or the central connector 4 are upholstered as well. In the case of the central connector, said connector is either made available for direct connection to in particular an external controller or a cable assembly of a vehicle or a bus of a vehicle, in particular a central bus, after upholstering or is directly connected to said controller, cable assembly or bus prior to upholstering.

Although the present invention has hitherto been described entirely by way of preferred embodiments, it is not restricted thereto, but rather can be modified in various ways.

### LIST OF REFERENCE SIGNS

1 massage device
2 massage unit
3 upholstery
4 control device or central connector
5 connection apparatus
6 cable
7 cable harness
8 recess
9 group
10 vehicle seat
11 cover
12 base
13 seat surface
14 backrest
15 headrest
16 guide rail
17 connection point

1. A massage device for a vehicle seat, comprising: a number of massage units which can be integrated in upholstery of a vehicle seat; a control device which is designed to activate the massage units, or a central connector which provides a connection for controlling the massage units; and
a connection apparatus which couples the massage units to the control device or the central connector;
wherein at least one of the control device, the central connector, the massage units and the connection apparatus comprises means for ensuring that at least the massage units are installed in a manner that is unique in terms of position and orientation.

2. The massage device of claim 1, wherein
the connection apparatus is asymmetrical.

3. The massage device of claim 1, wherein
characterised in that
the connection apparatus is designed such that the control device or the central connector is arranged asymmetrically.

4. The massage device of claim 3, wherein
the massage units are provided so as to be arranged symmetrically in a vehicle seat, and the connection apparatus accordingly connects each of the massage units to the control device or the central connector by means of a cable, the each cable having an asymmetrical structure.

5. The massage device of claim 3, wherein
an individual cable length is assigned to each massage unit.

6. The massage device of claim 1, wherein
at least the connection apparatus is provided so as to be foamed into the upholstery.

7. The massage device of claim 1, wherein
at least the control device or the central connector is provided so as to be foamed into the upholstery.

8. The massage device of claim 1, wherein
the massage units provided for being integrated at different points in the upholstery are colour-coded on the outside thereof so as to be inserted into colour-coded recesses that are accordingly provided in the upholstery.

9. The massage device of claim 1, wherein
the massage units provided for being integrated at different points in the upholstery or cables of the connection apparatus that are provided for being integrated at different points in the upholstery are colour-coded so as to be inserted at colour-coded points or in colour-coded recesses that are accordingly provided in the upholstery.

10. The massage device of claim 1, wherein
some of the massage units or some parts of the connection apparatus are preassembled or pre-cabled in groups.

11. The massage device of claim 11, wherein
the connections of each group are combined in a common cable.

12. A vehicle seat, such as for motor vehicles, the vehicle seat comprising:
a piece of upholstery;
a cover which is stretched over the upholstery; and
a massage device for a vehicle seat, the massage device comprising: a number of massage units which can be integrated in upholstery of a vehicle seat; a control device which is designed to activate the massage units or a central connector which provides a connection for controlling the massage units; and a connection apparatus which couples the massage units to the control device or the central connector; wherein at least one of the control device, the central connector, the massage units and the connection apparatus comprise means for ensuring that at least the massage units are installed in a manner that is unique in terms of position and orientation and wherein at least the massage units are provided so as to be integrated in the upholstery.

13. The vehicle seat of claim 12, wherein
the massage units and at least part of the connection apparatus are arranged so as to be covered by the cover or so as not to be visible from the outside.

14. A method for producing a vehicle seat, the method comprising:
providing a massage device for a vehicle seat, the massage device comprising: a number of massage units which can be integrated in upholstery of a vehicle seat; a control device which is designed to activate the massage units or a central connector which provides a connection for controlling the massage units; and a connection apparatus which couples the massage units to the control device or the central connector; wherein at least one of the control device, the central connector, the massage units and the connection apparatus comprises means for ensuring that at least the massage units are installed in a manner that is unique in terms of position and orientation;
providing upholstery, which has recesses for inserting the massage units; and
inserting the massage units into the recesses provided therefor.

15. The method according to claim 14, wherein
the individual massage units are inserted according to colour or shape coding provided on the massage units and on the recesses.

16. The method of claim 14, wherein
a step of contacting the connection apparatus is provided which comprises at least one of:
connecting the massage units to asymmetrically arranged cables of different lengths, a cable length specified by the arrangement of the associated recesses being assigned to each massage unit;
connecting cables integrated in the massage units to the controller or the central connector; and
connecting a common connection cable of a group of massage units to the controller or the central connector or a cable harness connected to the controller or the central connector.

17. The method of claim 14, wherein
a step of connecting a cable harness of the massage device to a control device of the massage device is provided.

18. The massage device of claim 5, wherein a cable length specified by the arrangement of associated recesses provided in upholstery of a vehicle seat in order to receive the massage units.

19. The vehicle seat of claim 13, wherein the massage units and at least part of the connection apparatus are arranged so as not to be visible from the outside by means of an additional foam layer arranged between the massage devices and the cover.

20. The method of claim 14, wherein a step of connecting a central connector of the massage device to an external controller, a cable assembly of a vehicle or a bus of a vehicle is provided.
